(19) United States
(12) Patent Application Publication
(10) Pub. No.: US 2017/0074346 A1
(43) Pub. Date: Mar. 16, 2017

(54) NOZZLE PLATE FOR AN AXIALLY DAMPING HYDRAULIC BEARING

(71) Applicant: BOGE Elastmetall GmbH, Damme (DE)

(72) Inventors: Thomas Kirchhoff, Sinzig-Westum (DE); Marc Stira, Bonn (DE); Karl-Emst Poss, Bonn (DE); Stefan Worms, Sinzig (DE)

(73) Assignee: BOGE Elastmetall GmbH, Damme (DE)

(21) Appl. No.: 15/119,999

(22) PCT Filed: Feb. 19, 2015
(86) PCT No.: PCT/EP2015/053485

§ 371 Date: Aug. 18, 2016

(30) Foreign Application Priority Data
Feb. 19, 2014 (DE) 10 2014 202 999.6

(51) Int. Cl. F16F 13/10; F16F 13/26; B60K 5/12

(52) U.S. Cl. CPC F16F 13/107; B60K 5/1208; F16F 13/262; F16F 2230/32

(57) ABSTRACT

A nozzle plate for an axially damping hydraulic mount having a passage disk with a passage for connecting a work chamber and a balance chamber of a hydraulic mount. The passage disk is rotationally fixable at a first angular position in the hydraulic mount. The nozzle plate also has a cover disk with an aperture that is arranged above the passage at a pre-definable angular position. The passage of the passage disk is bound on one side by the cover disk. The aperture forms an inlet opening into the passage or an outlet opening out of the passage for a fluid damping agent. The cover disk is rotationally fixed such that the aperture is at a second angular position selected from a plurality of different angular positions with respect to the passage disk.

### CROSS REFERENCE TO RELATED APPLICATION

This application claims priority to international patent application Serial No. PCT/EP2015/053485, filed Feb. 19, 2015, which claims priority to international patent application Serial No. DE 2014 202 996.6, filed Feb. 19, 2014, the contents of which are incorporated herein in their entirety.

### FIELD OF THE INVENTION

The invention relates to a nozzle plate for an axially damping hydraulic mount. Such hydraulic mounts are used in automotive manufacturing as engine mounts or as unit mounts for damping vibrations transmitted to the car body from the internal combustion engine.

### BACKGROUND OF THE INVENTION

DE 34 10 781 A1 and U.S. Pat. No. 4,909,490 A disclose vibration dampers. Such an engine mount or unit mount damper substantially comprises a metallic mount core via which the mount is fastened to the engine or to the unit; a typically two-part outer casing; and a frustoconical elastomeric supporting body arranged between the mount core and an upper part of the outer casing. Depending on the embodiment, the aforesaid parts are received by a housing by which the parts of the outer casing of the mount are frequently also held together. If the mounts are equipped with hydraulic damping, the aforesaid elastomer support body surrounds a work chamber for receiving a fluid damping agent. This work chamber is separated from a balance chamber by a separating element, namely a membrane, a so-called nozzle plate or the like, extending transversely to the mount axis. The balance chamber is encompassed by an elastomer bellows, which is in turn protected by a lower part of the outer casing. The work chamber and the balance chamber are connected to one another in the region of the separating element spatially separating them from one another by a passage, which enables the transfer of fluid damping agent between the work chamber and the balance chamber.

The fluid damping agent can hereby escape from the work chamber into the balance chamber during compression in the case of vibrations acting axially on the mount and can move out of the balance chamber into the work chamber again during rebound. An additional damping for axially acting vibrations is given by the oscillating to and fro of the fluid damping agent.

The damping properties of the hydraulic damping are inter alia influenced by the pumping surface of the support body, by the length and by the cross-section, as well as by the friction within the passage in the nozzle plate. A horizontally divided nozzle plate is known from the above-named DE 34 10 781 A1, wherein the upper plate half is fixedly installed in the vehicle and the lower plate half is rotatable with respect to the upper plate half, whereby the length and the cross-section of the nozzle passage, and thus the damping properties, can be changed. Thus, a setting of individual damping properties is possible in the installed state.

In such a hydraulic mount, the upper plate half has at its lower side a nose of arcuate form, which rises in the manner of a ramp and which merges at its end which tapers into a flat form into a tangentially adjoining inlet opening, which passes through the upper plate half. A nozzle passage which is likewise of arcuate form and which rises in a helical, flat manner is cut into the lower plate half in a manner corresponding to this nose such that said nozzle passage cuts the lower side of the lower plate half in the region of the outlet opening and runs out in a flat manner at the upper side at the other end. Such a hydraulic mount can require more construction space or a different fastening to the vehicle due to the construction of said hydraulic mount than with conventional hydraulic mounts without an adjustable nozzle plate.

It is the object of the present invention to provide a nozzle plate for an axially damping hydraulic mount which can be used or installed in existing hydraulic mounts and which enables an adaptation of damping properties of the hydraulic mount to different vehicle types.

### SUMMARY

In accordance with the invention, a nozzle plate for an axially damping hydraulic mount is provided, said nozzle plate having a passage disk having a passage for connecting the work chamber and the balance chamber of the hydraulic mount, wherein the passage disk is rotationally fixed in the hydraulic mount, and wherein the passage is bounded by a cover disk toward one side which is rotationally fixed with respect to the passage disk in one of different radial positions, and wherein the cover disk has an aperture which is arranged above the passage at a radial position which can be predefined and which forms an inlet opening or an outlet opening for a fluid damping agent into the passage or out of the passage respectively.

The nozzle plate in accordance with the invention enables a presetting of the damping properties of the hydraulic mount. For this purpose, the cover disk is brought into a desired radial position and is rotationally fixed with respect to the passage disk. The inlet opening (or outlet opening) formed by the aperture in the cover disk is thereby radially displaced with respect to an outlet opening (inlet opening) formed in the passage disk. As a consequence of this, the effective passage length changes, i.e. the length that the fluid damping agent covers to move from the work chamber into the balance chamber. The damping properties can thus be adapted to the vehicle type in which the hydraulic mount provided with the nozzle plate is to be installed.

The cover disk is rotationally fixed with respect to the passage disk. A changing of the radial position of the cover disk with respect to the passage disk is not available after the fixing and installation in a vehicle. On the one hand, this simplifies the structure of the nozzle plate. Since the passage extends within the passage disk, the cover disk can be of space-saving design so that the nozzle plate does not take up more construction space than is the case with conventional, non-adjustable nozzle plates. Existing hydraulic mounts can consequently be retrofitted substantially without adaptation.

Also, the rotationally fixed fixing prevents any unwanted adjustment of the damper properties during operation, for example, due to vibrations.

The term nozzle plate is generally to be understood as a separating element which separates the work chamber and the balance chamber from one another and which has a passage through which a fluid damping agent, in particular hydraulic oil, can flow from the work chamber into the balance chamber and back.

In an embodiment of the nozzle plate, the cross-sectional area of the passage changes over the length of the passage. For example, the passage width and/or the passage depth and/or the inclination of a passage wall change(s) over the length of the passage. The cross-section of the effective passage section, i.e. of that section through which the fluid damping agent has to flow to move from the work chamber into the balance chamber (and back), thus also changes due to a change of the effective passage length.

This embodiment is based on the recognition that there is the following relationship between the position of the damping maximum “f” and the passage length “l” and the passage cross-section “a”:

f˜√(a/l)

In other words, the damping properties depend both on the length and on the cross-section within the effective passage section. Accordingly, the damping properties can be adapted in two dimensions.

The change of the cross-sectional area over the length of the passage can be continuous. In an alternative embodiment of the invention, the cross-sectional area changes step-wise. In accordance with this embodiment, the damping properties are adjusted step-wise. For example, the effective passage length can be settable in steps of 30° between a smallest passage length (e.g. 50°) and a largest passage length (e.g. 320°).

The passage can have a predefined cross-sectional extent independent of the radial position of the cover disk. In other words, the actual cross-section of the passage is not changed by changing the radial position of the cover disk. Instead, which section of the passage is effective, i.e. which section has to be flowed through by the fluid damping agent to move from the work chamber into the balance chamber (and back), is determined by a change of the radial position of the cover disk.

Accordingly, the part section of the passage bounded by the cover disk can have a constant height and/or width over the length of the passage in cross-section. In this respect, the height can also be zero, which means that the passage extends completely within the passage disk and the cover disk can be of a particularly flat design. Such a cover disk can at least be manufactured simply and in a space-saving manner.

In an embodiment, the cover disk is rotationally fixedly latched with respect to the passage disk. It is thereby more difficult for the radial position of the cover disk to change with respect to the passage disk, and thus to change the damping properties, after installation. In addition, a step-wise setting of the damping properties can be made possible by suitable latching means, e.g. in the form of cut-outs and corresponding latching projections at the cover disk or at the passage disk respectively.

An axially damping hydraulic mount is furthermore provided in accordance with the invention comprising a work chamber for receiving a fluid damping agent and a balance chamber for the fluid damping agent and a nozzle plate, as described above, extending between the work chamber and the balance chamber transversely to the mount axis, with the nozzle plate being rotationally fixed in the hydraulic mount. The axially damping hydraulic mount in this respect has a support body arranged between a mount core and an upper housing part and a bellows protected by a lower housing part. The balance chamber is encompassed by the bellows.

The damping properties of such a hydraulic mount can be preset, but an adjustment of the damping properties in operation is prevented.

In an embodiment of the hydraulic mount, the aperture in the cover disk opens into the work chamber, with the cross-sectional area of the passage increasing over the length of the passage starting from the aperture in the cover disk. The passage thus initially has the required small passage cross-section at maximum length for low-frequency turnings (e.g. 7 Hz). The passage cross-section opens for higher frequency tunings with shorter passages.

### BRIEF DESCRIPTION OF THE DRAWINGS

An embodiment of the invention is described in more detail in the following with reference to the following figures. It shows in a schematic representation:

FIG. 1 is a cross section of a hydraulic mount in accordance with an embodiment of the present invention in cross-section;

FIG. 2 is a partly sectional representation of a nozzle plate in accordance with an embodiment of the invention;

FIG. 3 shows a cover disk of the nozzle plate in accordance with FIG. 2;

FIG. 4 is a plan view of a passage disk of the nozzle plate in accordance with FIG. 2;

FIG. 5 shows a cross-section through AA of the passage disk in FIG. 4; and

FIG. 6 is a schematic representation of an adjustment of the nozzle plate in accordance with FIG. 2.

### DETAILED DESCRIPTION OF THE INVENTION

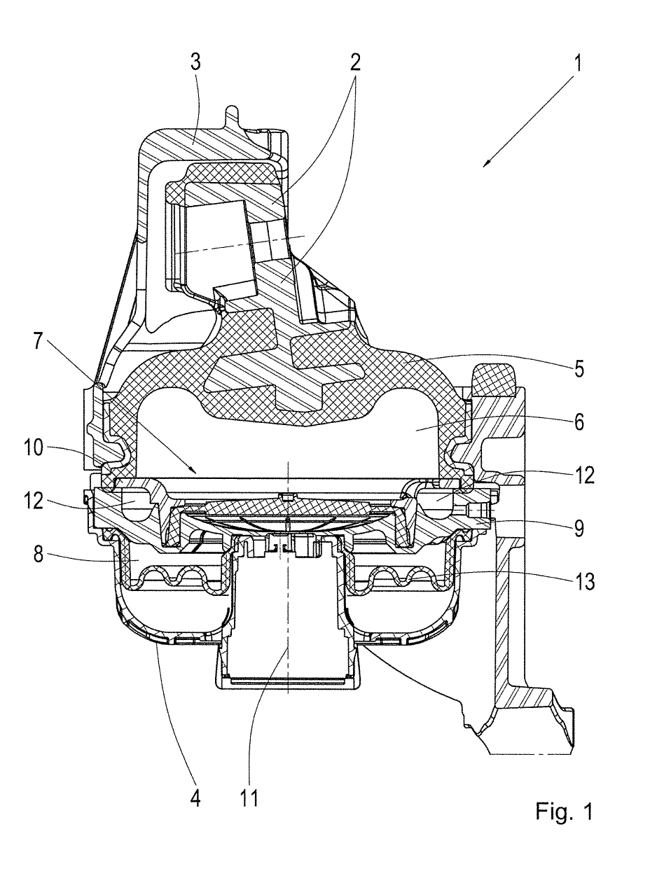

FIG. 1 shows a cross-section through a hydraulic mount 1 in accordance with an embodiment of the present invention. The hydraulic mount 1 comprises a mount core 2 as well as a two-part outer casing having an upper housing part 3 and a lower housing part 4. An elastomeric support body 5 is arranged between the mount core 2 and the upper housing part 3. The mount core 2 is supported against the upper housing part 3 via the support body 5. The mount core 2 serves the fastening of the hydraulic mount 1 at the installation site in the motor vehicle. The support body 5 surrounds a work chamber 6 for receiving a fluid damping agent. The work chamber 6 is spatially separated from a balance chamber 8, which is disposed below in the axial direction. The nozzle plate 7 comprises a passage disk 9 and a passage cover disk 10, which are clamped transversely to a mount axis 11. A passage 12 running around at the periphery of the nozzle plate 7 is encompassed by the passage disk 9 and the passage cover disk 10. The passage 12 allows the transfer of fluid damping agent between the work chamber 6 and the balance chamber 8. The passage disk 9 has at its outer right side a closable filling opening for filling the hydraulic mount 1 with the fluid damping agent. The center axis of the filling opening is arranged perpendicular to the mount axis 11. The balance chamber 8 is encompassed at its lower side by an elastomeric bellows 13, which is surrounded by the lower housing part 4 for mechanical protection.

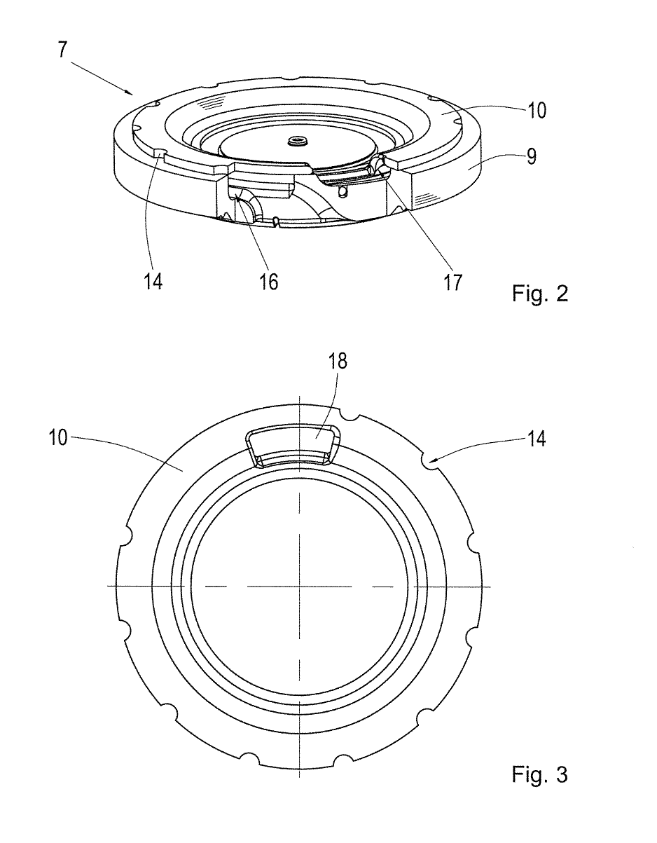

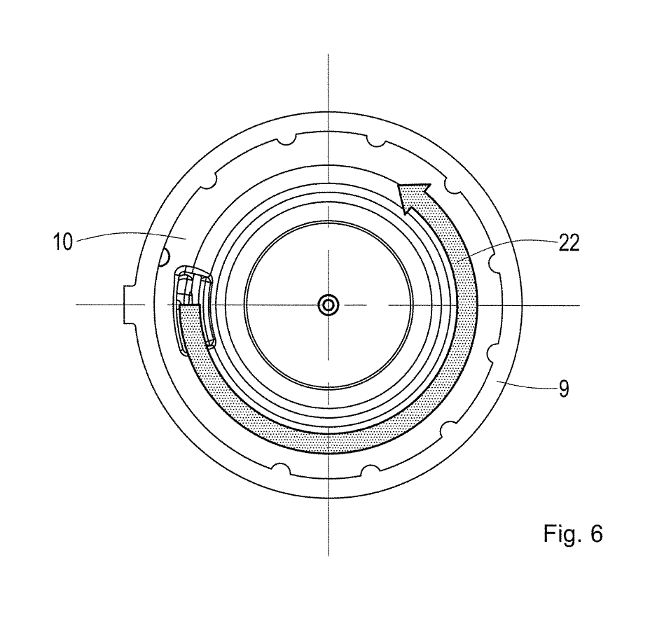

FIG. 2 shows the nozzle plate 7 in accordance with an embodiment of the invention in a partly sectional representation. The passage cover disk 10 is rotationally fixed on the passage disk 9. For this purpose, cut-outs 14 are provided at the periphery of the passage cover disk 10 and one or more corresponding, axially projecting latching projections 15 (FIG. 5) at the periphery of the passage disk 9 can engage into them. The effective length and cross-section of the passage 12 can be preset stepwise by rotationally fixing the passage cover disk 10 with respect to the passage disk 9 before the nozzle plate 7 is installed in the hydraulic mount 1 and the hydraulic 1 is installed in the vehicle. Once installation has taken place, a further adjustment of the effective length or of the effective cross-section is no longer possible or available.

The passage disk 9 and the passage disk cover 10 bound the passage 12, with the passage 12 extending in arcuate form along the periphery of the passage disk 9 and of the passage cover disk 10. A passage outflow 16 is formed in the passage disk 9 and opens into the balance chamber 8 in the installed state. A passage inflow 17, which opens into the work chamber 6 in the installed state, is provided at the axially opposite side of the nozzle plate 7. The passage inflow 17 is defined by an aperture 18 in the passage cover disk 10. The radial position of the aperture 18 and thus of the passage inflow 17 can be preset by rotation, i.e. by changing the radial positioning of the passage cover disk 10.

FIG. 3 shows the passage cover disk 10 without the passage disk 9. The passage cover disk 10 having the aperture 18 may be manufactured in one piece from plastic.

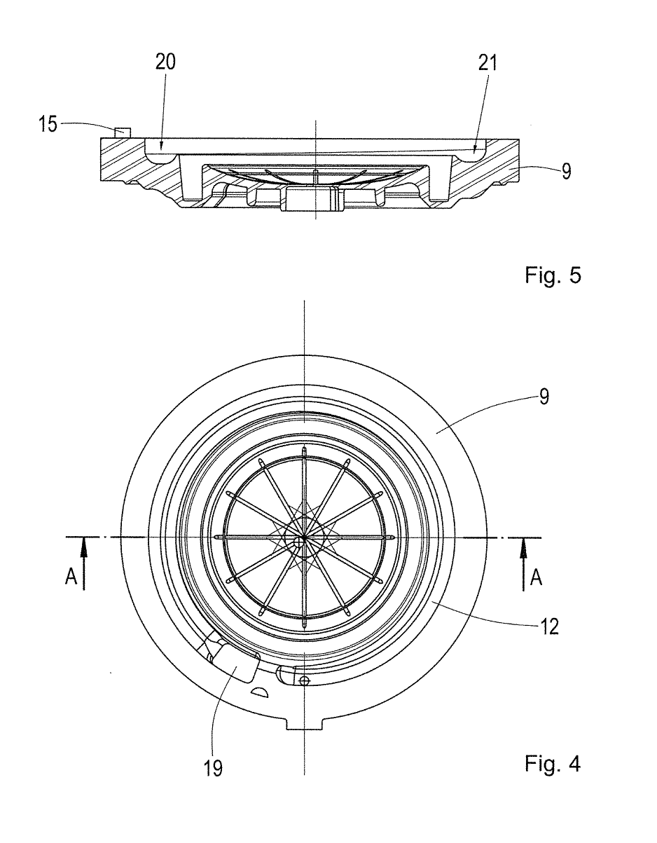

FIG. 4 shows a plan view of the passage disk 9. In the example shown, the passage 12 runs practically along the total periphery of the passage disk 9. The passage disk 9 has an aperture 19 at an end of the passage 12. The aperture 19 forms the above-mentioned passage outflow 16 (FIG. 2).

The passage disk 9 may likewise be manufactured in one piece from plastic.

FIG. 5 shows a cross-section through the passage disk 9 along the line A-A in FIG. 4. It can be seen therein that the passage 12 has different cross-sectional areas at the points 20 and 21. The passage cross-section changes continuously over the length of the passage 12. The cross-sectional area in particular decreases continuously starting from the aperture 19 in the passage disk 9. The cross-sectional area increases toward the passage outflow 16 starting from the passage inflow 17. The area change can take place by changing the passage cross-section in an axial and/or radial direction.

FIG. 6 shows the passage disk 9 with a passage cover disk 10 placed on. As shown by the arrow 22, the passage cover disk 10 can be rotated with respect to the passage disk 9 and can be brought into a desired radial position before the passage disk 9 and the passage cover disk 10 are rotationally fixed with respect to one another for the further installation. The radial position of the passage inflow 17 is changed relative to the passage outflow 16 by rotation. The effective length and the effective cross-section of the passage 12 thus change.

### REFERENCE NUMERALS

1 hydraulic mount
2 mount core
3 upper housing part
4 lower housing part
5 support body
6 work chamber
7 nozzle plate
8 balance chamber
9 passage disk
10 passage cover disk
11 mount axis
12 passage
13 bellows
14 cut-out
15 latching projection
16 passage outflow
17 passage inflow
18 aperture in the passage cover disk
19 aperture in the passage disk
20 first cross-sectional area
21 second cross-sectional area
22 direction of rotation

1-14. (canceled)

15. A nozzle plate for an axially damping hydraulic mount of the type having a work chamber and a balance chamber, the nozzle plate comprising:
a passage disk with a passage for connecting a work chamber and a balance chamber of a hydraulic mount, the passage disk being rotationally fixable at a first angular position in the hydraulic mount; and
a cover disk, the passage of the passage disk being bound on one side by the cover disk, the cover disk having an aperture that is arranged above the passage of the passage disk at a pre-definable angular position, the aperture forming an inlet opening into the passage or an outlet opening out of the passage for a fluid damping agent, the cover disk being rotationally fixed such that the aperture is at a second angular position selected from a plurality of different angular positions with respect to the passage disk.

16. The nozzle plate of claim 15, wherein the passage of the passage disk has a length and a cross-sectional area, and the cross-sectional area changes over the length of the passage of the passage disk.

17. The nozzle plate of claim 16, wherein the passage of the passage disk has a passage width, a passage depth and an inclination of a passage wall, and the passage width, the passage depth and/or the inclination of the passage wall changes over the length of the passage.

18. The nozzle plate of claim 16, wherein the cross-sectional area of the passage changes step-wise over the length of the passage of the passage disk.

19. The nozzle plate of claim 16, wherein the passage of the passage disk has a predefined cross-sectional area independent of an angular position of the cover disk.

20. The nozzle plate of claim 16, wherein a section of the passage bounded by the cover disk has a constant cross-sectional height and/or width over the length of the passage.

21. The nozzle plate of claim 15, wherein the cover disk is latched in an angular position with respect to the passage disk.

22. The nozzle plate of claim 15, wherein the passage disk and/or the cover disk is/are respectively formed in one piece from plastic.

23. The nozzle plate of claim 16, wherein the cross-sectional area of the passage changes continuously over the length of the passage of the passage disk.

24. The nozzle plate of claim 23, wherein a passage inflow is defined by the aperture in the cover disk, the passage disk having an aperture at one end of the passage, the aperture at one end forming a passage outflow, and the cross-sectional area of the passage reduces continuously starting from the aperture in the passage disk to the aperture in the cover disk.

25. The nozzle plate of claim 23, wherein the angular position of the aperture in the cover disk, and thus of the passage inflow is presettable by changing an angular positioning of the passage cover disk.

26. The nozzle plate of claim 15, further comprising:
a work chamber for receiving the fluid damping agent and a balance chamber for the fluid damping agent,
wherein the nozzle plate extends between the work chamber and the balance chamber transversely to a hydraulic mount axis, with the nozzle plate is rotationally fixed in the hydraulic mount.

27. The nozzle plate of claim 26, wherein the aperture in the cover disk opens into the work chamber and the cross-sectional area of the passage increases over the length of the passage starting from the aperture.

28. The nozzle plate of claim 26, wherein the aperture in the cover disk opens into the work chamber and the cross-sectional area of the passage increases continuously over the length of the passage starting from the aperture.

29. An axially damping hydraulic mount comprising:
a work chamber for receiving a fluid damping agent;
a balance chamber for the fluid damping agent; and
a nozzle plate extending between the work chamber and the balance chamber transversely to a hydraulic mount axis, with the nozzle plate being rotationally fixed in the hydraulic mount, the nozzle plate further comprising;
a passage disk with a passage for connecting the work chamber and the balance chamber of the hydraulic mount, the passage disk being rotationally fixed at a first angular position in the hydraulic mount; and
a cover disk, the passage of the passage disk being bound on one side by the cover disk, the cover disk having an aperture that is arranged above the passage of the passage disk at a pre-definable angular position, the aperture forming an inlet opening into the passage or an outlet opening out of the passage for the fluid damping agent, the cover disk being rotationally fixed such that the aperture is at a second angular position selected from a plurality of different angular positions with respect to the passage disk.

30. The hydraulic mount of claim 29, wherein the passage of the passage disk has a length and a cross-sectional area, and the cross-sectional area changes over the length of the passage of the passage disk.
